(19) United States
(12) Patent Application Publication
(10) Pub. No.: US 2024/0275630 A1
(43) Pub. Date: Aug. 15, 2024

(54) METHOD AND DEVICE FOR CONTROLLING CONTROLLED DEVICE BY OBTAINING AND ANALYZING MEDIA DATA BY CONTROL DEVICE IN WIRELESS LAN SYSTEM OF SMART HOME ENVIRONMENT

(71) Applicant: LG ELECTRONICS INC., Seoul (KR)

(72) Inventors: Jungwook PARK, Seoul (KR); Byungjoo LEE, Seoul (KR); Hangyu CHO, Seoul (KR); Jeonghwan KIM, Seoul (KR); Youngjun JO, Seoul (KR); Younghak HWANG, Seoul (KR)

(73) Assignee: LG ELECTRONICS INC., Seoul (KR)

(21) Appl. No.: 18/566,773

(22) PCT Filed: Jun. 7, 2022
(86) PCT No.: PCT/KR2022/008005

§ 371 Date: Dec. 4, 2023

(30) Foreign Application Priority Data
Jun. 7, 2021 (KR) 10-2021-0073668

(51) Int. Cl. H04L 12/28

(52) U.S. Cl. CPC H04L 12/2816; H04L 12/2807; H04L 2012/285

(57) ABSTRACT

Provided are a method and device for controlling a controlled device by obtaining and analyzing media data by a control device in a wireless LAN system of a smart home environment. Particularly, the control device obtains media data. The control device analyzes the result on the basis of the media data. The control device controls the controlled device on the basis of the analyzed result. The media data is obtained on the basis of a cable, file input, broadcasting and internet streaming.

### CROSS-REFERENCE TO RELATED APPLICATIONS

This application is the National Stage filing under 35 U.S.C. 371 of International Application No. PCT/KR2022/008005, filed on Jun. 7, 2022, which claims the benefit of earlier filing date and right of priority to Korean Application No. 10-2021-0073668, filed on Jun. 7, 2021, the contents of which are all hereby incorporated by reference herein in their entireties.

### TECHNICAL FIELD

The present specification relates to a method for setting IoT devices in a wireless LAN system in a smart home environment, and more particularly, to a method and apparatus for setting an IoT device in a wireless LAN system of a smart home environment, and more particularly, to a method and apparatus for a controller to acquire and analyze media data and control a controlee.

### BACKGROUND

Amazon, Apple, Google and the Zigbee Alliance today announced a new joint working group to advance the development and adoption of a new, royalty-free connectivity standard that increases compatibility among smart home products and embeds security into fundamental design principles. IKEA, Legrand, NXP Semiconductors, Resideo, Samsung SmartThings, Schneider Electric, Signify (Philips Hue), Silicon Labs, Somfy, Wulian, and ThinQ (LG Electronics) etc., which constitute the board of directors of the Zigbee Alliance will also join the joint committee and contribute to the project toward a common goal.

The goal of the Connected Home over IP project is to simplify development for manufacturers and increase compatibility for consumers. The project is based on the common belief that smart home devices must ensure security, stability and seamless usability. The project aims to enable communication between smart home devices, mobile apps, and cloud services based on the Internet Protocol (IP), and to define a set of specific IP-based networking technologies for device authentication.

An industry joint committee adopts an open source approach in the development and implementation of new integrated connectivity protocols. The project will utilize market-proven smart home technologies from Amazon, Apple, Google, and the Zigbee Alliance. The decision to leverage these technologies is expected to accelerate the protocol development process and deliver benefits quickly to manufacturers and consumers.

The project aims to simplify the creation of devices compatible with smart homes and voice-recognition services such as Amazon's Alexa, Apple's Sir, and Google's Assistant for device makers. The forthcoming protocol will complement existing technologies, and the Joint Committee members encourage device manufacturers to continue to pursue innovations based on existing technologies.

The Connected Home over IP project encourages device manufacturers, silicon providers and developers in the smart home industry to participate in and contribute to standards development.

### SUMMARY

This specification proposes a method and apparatus for a controller to acquire and analyze media data and control a controlee in a wireless LAN system of a smart home environment.

An example of the present specification proposes a method for a controller to acquire and analyze media data and control a controlee.

This embodiment proposes a method in which the controller (IoT controller) analyzes the necessary data in the process of acquiring and processing media data such as video, audio, and subtitles, and operates or controls controlee (IoT controlee or peripheral devices) connected to controller such as lights, fans, and blinds based on the analyzed data.

A controller acquires media data.

The controller analyzes a result based on the media data.

The controller controls a controlee based on the analyzed result.

The media data is obtained based on cable, file input, broadcasting, and Internet streaming. The cable may be a cable for transmitting video/audio signals, such as High-Definition Multimedia Interface (HDMI) or DisplayPort (DP). The broadcasting may refer to a method of transmitting broadcasts using radio waves, such as TV. The Internet streaming is a method of playing audio or video in real time on the Internet, and may refer to a streaming service such as YouTube or Netflix.

According to the embodiment proposed in this specification, the IoT controller acquires and analyzes the media data and controls peripheral devices with the analyzed result, which has the effect of allowing users to consume media more conveniently and immersively without user intervention. For example, in interpreting media data for consumption, through deep learning, artificial intelligence, etc., the color, brightness, and scenario that the current media data is intended to express are analyzed and the lighting, curtains, temperature, wind, etc. of surrounding devices are adjusted, and it can allow users to consume media in an immersive way.

### BRIEF DESCRIPTION OF THE DRAWINGS

FIG. 1 shows an example of a transmitting apparatus and/or receiving apparatus of the present specification.

FIG. 2 is a conceptual view illustrating the structure of a wireless local area network (WLAN).

FIG. 3 illustrates a general link setup process.

FIG. 4 shows Zigbee device types.

FIG. 5 shows a Zigbee stack.

FIG. 6 shows a modified example of the transmitting device and/or the receiving device of the present specification.

FIG. 7 shows the configuration of Controller proposed in this embodiment.

FIG. 8 shows the connection structure of Controller and Controlee.

FIG. 9 shows a procedure for controlling Controlees during the media decoding process.

FIG. 10 shows an embodiment of controlling Controlees during the media decoding process.

FIG. 11 is an example of coding showing control processing commands for Controlees during the media decoding process.

FIG. 12 shows the procedure for controlling Controlees after media playback processing.

FIG. 13 shows an example of control processing of Controlees after media playback processing.

FIG. 14 is an example of coding showing control processing commands for Controlees after media playback processing.

FIG. 15 is a flowchart illustrating a procedure in which a controller acquires and analyzes media data and controls a controlee according to this embodiment.

### DETAILED DESCRIPTION

In the present specification, “A or B” may mean “only A”, “only B” or “both A and B”. In other words, in the present specification, “A or B” may be interpreted as “A and/or B”. For example, in the present specification, “A, B, or C” may mean “only A”, “only B”, “only C”, or “any combination of A, B, C”.

A slash (/) or comma used in the present specification may mean “and/or”. For example, “A/B” may mean “A and/or B”. Accordingly, “A/B” may mean “only A”, “only B”, or “both A and B”. For example, “A, B, C” may mean “A, B, or C”.

In the present specification, “at least one of A and B” may mean “only A”, “only B”, or “both A and B”. In addition, in the present specification, the expression “at least one of A or B” or “at least one of A and/or B” may be interpreted as “at least one of A and B”.

In addition, in the present specification, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in the present specification may mean “for example”. Specifically, when indicated as “control information (EHT-signal)”, it may denote that “EHT-signal” is proposed as an example of the “control information”. In other words, the “control information” of the present specification is not limited to “EHT-signal”, and “EHT-signal” may be proposed as an example of the “control information”. In addition, when indicated as “control information (i.e., EHT-signal)”, it may also mean that “EHT-signal” is proposed as an example of the “control information”.

Technical features described individually in one figure in the present specification may be individually implemented, or may be simultaneously implemented.

The following example of the present specification may be applied to various wireless communication systems. For example, the following example of the present specification may be applied to a wireless local area network (WLAN) system. For example, the present specification may be applied to the IEEE 802.11a/g/n/ac standard or the IEEE 802.11ax standard. In addition, the present specification may also be applied to the newly proposed EHT standard or IEEE 802.11be standard. In addition, the example of the present specification may also be applied to a new WLAN standard enhanced from the EHT standard or the IEEE 802.11be standard. In addition, the example of the present specification may be applied to a mobile communication system. For example, it may be applied to a mobile communication system based on long term evolution (LTE) depending on a 3^{rd} generation partnership project (3GPP) standard and based on evolution of the LTE. In addition, the example of the present specification may be applied to a communication system of a 5G NR standard based on the 3GPP standard.

Hereinafter, in order to describe a technical feature of the present specification, a technical feature applicable to the present specification will be described.

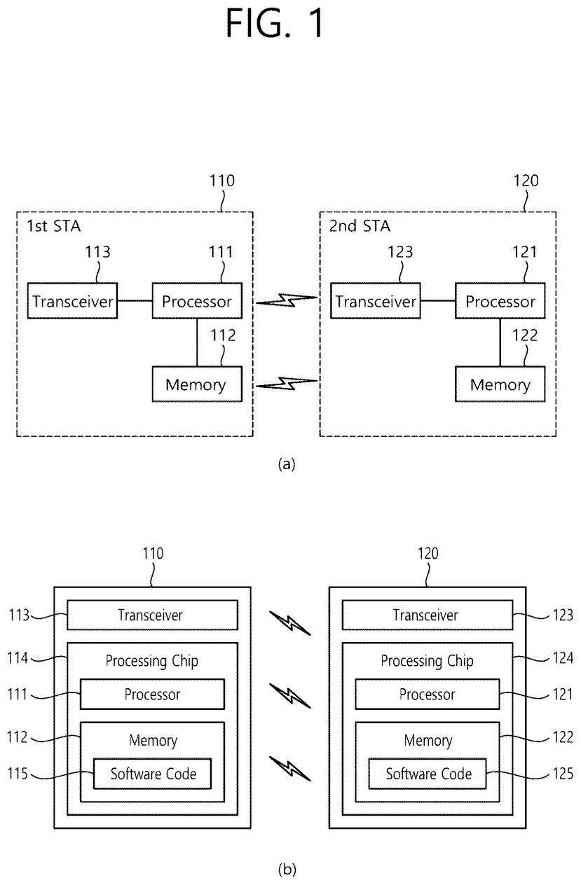

FIG. 1 shows an example of a transmitting apparatus and/or receiving apparatus of the present specification.

In the example of FIG. 1, various technical features described below may be performed. FIG. 1 relates to at least one station (STA). For example, STAs 110 and 120 of the present specification may also be called in various terms such as a mobile terminal, a wireless device, a wireless transmit/receive unit (WTRU), a user equipment (UE), a mobile station (MS), a mobile subscriber unit, or simply a user. The STAs 110 and 120 of the present specification may also be called in various terms such as a network, a base station, a node-B, an access point (AP), a repeater, a router, a relay, or the like. The STAs 110 and 120 of the present specification may also be referred to as various names such as a receiving apparatus, a transmitting apparatus, a receiving STA, a transmitting STA, a receiving device, a transmitting device, or the like.

For example, the STAs 110 and 120 may serve as an AP or a non-AP. That is, the STAs 110 and 120 of the present specification may serve as the AP and/or the non-AP.

The STAs 110 and 120 of the present specification may support various communication standards together in addition to the IEEE 802.11 standard. For example, a communication standard (e.g., LTE, LTE-A, 5G NR standard) or the like based on the 3GPP standard may be supported. In addition, the STA of the present specification may be implemented as various devices such as a mobile phone, a vehicle, a personal computer, or the like. In addition, the STA of the present specification may support communication for various communication services such as voice calls, video calls, data communication, and self-driving (autonomous-driving), or the like.

The STAs 110 and 120 of the present specification may include a medium access control (MAC) conforming to the IEEE 802.11 standard and a physical layer interface for a radio medium.

The STAs 110 and 120 will be described below with reference to a sub-figure (a) of FIG. 1.

The first STA 110 may include a processor 111, a memory 112, and a transceiver 113. The illustrated process, memory, and transceiver may be implemented individually as separate chips, or at least two blocks/functions may be implemented through a single chip.

The transceiver 113 of the first STA performs a signal transmission/reception operation. Specifically, an IEEE 802.11 packet (e.g., IEEE 802.11 a/b/g/n/ac/ax/be, etc.) may be transmitted/received.

For example, the first STA 110 may perform an operation intended by an AP. For example, the processor 111 of the AP may receive a signal through the transceiver 113, process a reception (RX) signal, generate a transmission (TX) signal, and provide control for signal transmission. The memory 112 of the AP may store a signal (e.g., RX signal) received through the transceiver 113, and may store a signal (e.g., TX signal) to be transmitted through the transceiver.

For example, the second STA 120 may perform an operation intended by a non-AP STA. For example, a transceiver 123 of a non-AP performs a signal transmission/reception operation. Specifically, an IEEE 802.11 packet (e.g., IEEE 802.11a/b/g/n/ac/ax/be packet, etc.) may be transmitted/received.

For example, a processor 121 of the non-AP STA may receive a signal through the transceiver 123, process an RX signal, generate a TX signal, and provide control for signal transmission. A memory 122 of the non-AP STA may store a signal (e.g., RX signal) received through the transceiver 123, and may store a signal (e.g., TX signal) to be transmitted through the transceiver.

For example, an operation of a device indicated as an AP in the specification described below may be performed in the first STA 110 or the second STA 120. For example, if the first STA 110 is the AP, the operation of the device indicated as the AP may be controlled by the processor 111 of the first STA 110, and a related signal may be transmitted or received through the transceiver 113 controlled by the processor 111 of the first STA 110. In addition, control information related to the operation of the AP or a TX/RX signal of the AP may be stored in the memory 112 of the first STA 110. In addition, if the second STA 120 is the AP, the operation of the device indicated as the AP may be controlled by the processor 121 of the second STA 120, and a related signal may be transmitted or received through the transceiver 123 controlled by the processor 121 of the second STA 120. In addition, control information related to the operation of the AP or a TX/RX signal of the AP may be stored in the memory 122 of the second STA 120.

For example, in the specification described below, an operation of a device indicated as a non-AP (or user-STA) may be performed in the first STA 110 or the second STA 120. For example, if the second STA 120 is the non-AP, the operation of the device indicated as the non-AP may be controlled by the processor 121 of the second STA 120, and a related signal may be transmitted or received through the transceiver 123 controlled by the processor 121 of the second STA 120. In addition, control information related to the operation of the non-AP or a TX/RX signal of the non-AP may be stored in the memory 122 of the second STA 120. For example, if the first STA 110 is the non-AP, the operation of the device indicated as the non-AP may be controlled by the processor 111 of the first STA 110, and a related signal may be transmitted or received through the transceiver 113 controlled by the processor 111 of the first STA 110. In addition, control information related to the operation of the non-AP or a TX/RX signal of the non-AP may be stored in the memory 112 of the first STA 110.

In the specification described below, a device called a (transmitting/receiving) STA, a first STA, a second STA, a STA1, a STA2, an AP, a first AP, a second AP, an AP1, an AP2, a (transmitting/receiving) terminal, a (transmitting/receiving) device, a (transmitting/receiving) apparatus, a network, or the like may imply the STAs 110 and 120 of FIG. 1. For example, a device indicated as, without a specific reference numeral, the (transmitting/receiving) STA, the first STA, the second STA, the STA1, the STA2, the AP, the first AP, the second AP, the AP1, the AP2, the (transmitting/receiving) terminal, the (transmitting/receiving) device, the (transmitting/receiving) apparatus, the network, or the like may imply the STAs 110 and 120 of FIG. 1. For example, in the following example, an operation in which various STAs transmit/receive a signal (e.g., a PPDU) may be performed in the transceivers 113 and 123 of FIG. 1. In addition, in the following example, an operation in which various STAs generate a TX/RX signal or perform data processing and computation in advance for the TX/RX signal may be performed in the processors 111 and 121 of FIG. 1. For example, an example of an operation for generating the TX/RX signal or performing the data processing and computation in advance may include: 1) an operation of determining/obtaining/configuring/computing/decoding/encoding bit information of a sub-field (SIG, STF, LTF, Data) included in a PPDU; 2) an operation of determining/configuring/obtaining a time resource or frequency resource (e.g., a subcarrier resource) or the like used for the sub-field (SIG, STF, LTF, Data) included the PPDU; 3) an operation of determining/configuring/obtaining a specific sequence (e.g., a pilot sequence, an STF/LTF sequence, an extra sequence applied to SIG) or the like used for the sub-field (SIG, STF, LTF, Data) field included in the PPDU; 4) a power control operation and/or power saving operation applied for the STA; and 5) an operation related to determining/obtaining/configuring/decoding/encoding or the like of an ACK signal. In addition, in the following example, a variety of information used by various STAs for determining/obtaining/configuring/computing/decoding/decoding a TX/RX signal (e.g., information related to a field/subfield/control field/parameter/power or the like) may be stored in the memories 112 and 122 of FIG. 1.

The aforementioned device/STA of the sub-figure (a) of FIG. 1 may be modified as shown in the sub-figure (b) of FIG. 1. Hereinafter, the STAs 110 and 120 of the present specification will be described based on the sub-figure (b) of FIG. 1.

For example, the transceivers 113 and 123 illustrated in the sub-figure (b) of FIG. 1 may perform the same function as the aforementioned transceiver illustrated in the sub-figure (a) of FIG. 1. For example, processing chips 114 and 124 illustrated in the sub-figure (b) of FIG. 1 may include the processors 111 and 121 and the memories 112 and 122. The processors 111 and 121 and memories 112 and 122 illustrated in the sub-figure (b) of FIG. 1 may perform the same function as the aforementioned processors 111 and 121 and memories 112 and 122 illustrated in the sub-figure (a) of FIG. 1.

A mobile terminal, a wireless device, a wireless transmit/receive unit (WTRU), a user equipment (UE), a mobile station (MS), a mobile subscriber unit, a user, a user STA, a network, a base station, a Node-B, an access point (AP), a repeater, a router, a relay, a receiving unit, a transmitting unit, a receiving STA, a transmitting STA, a receiving device, a transmitting device, a receiving apparatus, and/or a transmitting apparatus, which are described below, may imply the STAs 110 and 120 illustrated in the sub-figure (a)/(b) of FIG. 1, or may imply the processing chips 114 and 124 illustrated in the sub-figure (b) of FIG. 1. That is, a technical feature of the present specification may be performed in the STAs 110 and 120 illustrated in the sub-figure (a)/(b) of FIG. 1, or may be performed only in the processing chips 114 and 124 illustrated in the sub-figure (b) of FIG. 1. For example, a technical feature in which the transmitting STA transmits a control signal may be understood as a technical feature in which a control signal generated in the processors 111 and 121 illustrated in the sub-figure (a)/(b) of FIG. 1 is transmitted through the transceivers 113 and 123 illustrated in the sub-figure (a)/(b) of FIG. 1. Alternatively, the technical feature in which the transmitting STA transmits the control signal may be understood as a technical feature in which the control signal to be transferred to the transceivers 113 and 123 is generated in the processing chips 114 and 124 illustrated in the sub-figure (b) of FIG. 1.

For example, a technical feature in which the receiving STA receives the control signal may be understood as a technical feature in which the control signal is received by means of the transceivers 113 and 123 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (a) of FIG. 1 is obtained by the processors 111 and 121 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (b) of FIG. 1 is obtained by the processing chips 114 and 124 illustrated in the sub-figure (b) of FIG. 1.

Referring to the sub-figure (b) of FIG. 1, software codes 115 and 125 may be included in the memories 112 and 122. The software codes 115 and 126 may include instructions for controlling an operation of the processors 111 and 121. The software codes 115 and 125 may be included as various programming languages.

The processors 111 and 121 or processing chips 114 and 124 of FIG. 1 may include an application-specific integrated circuit (ASIC), other chipsets, a logic circuit and/or a data processing device. The processor may be an application processor (AP). For example, the processors 111 and 121 or processing chips 114 and 124 of FIG. 1 may include at least one of a digital signal processor (DSP), a central processing unit (CPU), a graphics processing unit (GPU), and a modulator and demodulator (modem). For example, the processors 111 and 121 or processing chips 114 and 124 of FIG. 1 may be SNAPDRAGON™ series of processors made by Qualcomm®, EXYNOS™ series of processors made by Samsung™, A series of processors made by Apple®, HELIO™ series of processors made by MediaTek®, ATOM™ series of processors made by Intel® or processors enhanced from these processors.

In the present specification, an uplink may imply a link for communication from a non-AP STA to an SP STA, and an uplink PPDU/packet/signal or the like may be transmitted through the uplink. In addition, in the present specification, a downlink may imply a link for communication from the AP STA to the non-AP STA, and a downlink PPDU/packet/signal or the like may be transmitted through the downlink.

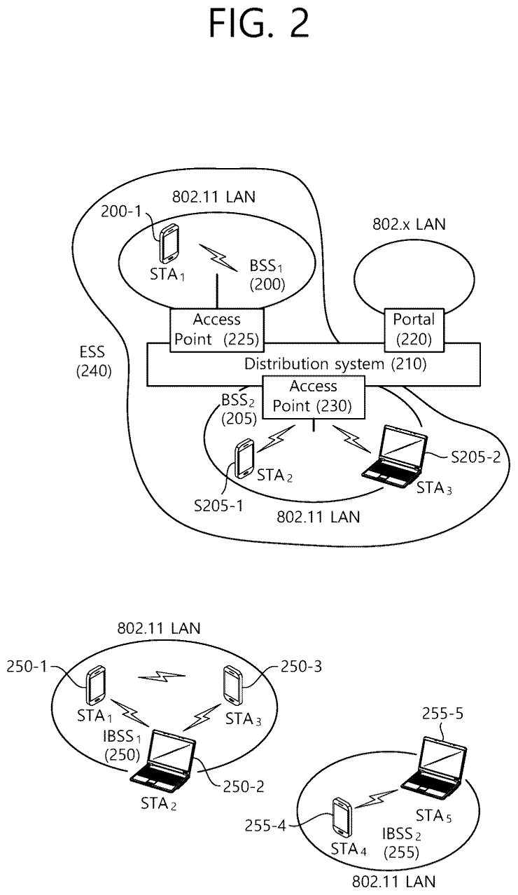

FIG. 2 is a conceptual view illustrating the structure of a wireless local area network (WLAN).

An upper part of FIG. 2 illustrates the structure of an infrastructure basic service set (BSS) of institute of electrical and electronic engineers (IEEE) 802.11.

Referring the upper part of FIG. 2, the wireless LAN system may include one or more infrastructure BSSs 200 and 205 (hereinafter, referred to as BSS). The BSSs 200 and 205 as a set of an AP and a STA such as an access point (AP) 225 and a station (STAT) 200-1 which are successfully synchronized to communicate with each other are not concepts indicating a specific region. The BSS 205 may include one or more STAs 205-1 and 205-2 which may be joined to one AP 230.

The BSS may include at least one STA, APs providing a distribution service, and a distribution system (DS) 210 connecting multiple APs.

The distribution system 210 may implement an extended service set (ESS) 240 extended by connecting the multiple BSSs 200 and 205. The ESS 240 may be used as a term indicating one network configured by connecting one or more APs 225 or 230 through the distribution system 210. The AP included in one ESS 240 may have the same service set identification (SSID).

A portal 220 may serve as a bridge which connects the wireless LAN network (IEEE 802.11) and another network (e.g., 802.X).

In the BSS illustrated in the upper part of FIG. 2, a network between the APs 225 and 230 and a network between the APs 225 and 230 and the STAs 200-1, 205-1, and 205-2 may be implemented. However, the network is configured even between the STAs without the APs 225 and 230 to perform communication. A network in which the communication is performed by configuring the network even between the STAs without the APs 225 and 230 is defined as an Ad-Hoc network or an independent basic service set (IBSS).

A lower part of FIG. 2 illustrates a conceptual view illustrating the IBSS.

Referring to the lower part of FIG. 2, the IBSS is a BSS that operates in an Ad-Hoc mode. Since the IBSS does not include the access point (AP), a centralized management entity that performs a management function at the center does not exist. That is, in the IBSS, STAs 250-1, 250-2, 250-3, 255-4, and 255-5 are managed by a distributed manner. In the IBSS, all STAs 250-1, 250-2, 250-3, 255-4, and 255-5 may be constituted by movable STAs and are not permitted to access the DS to constitute a self-contained network.

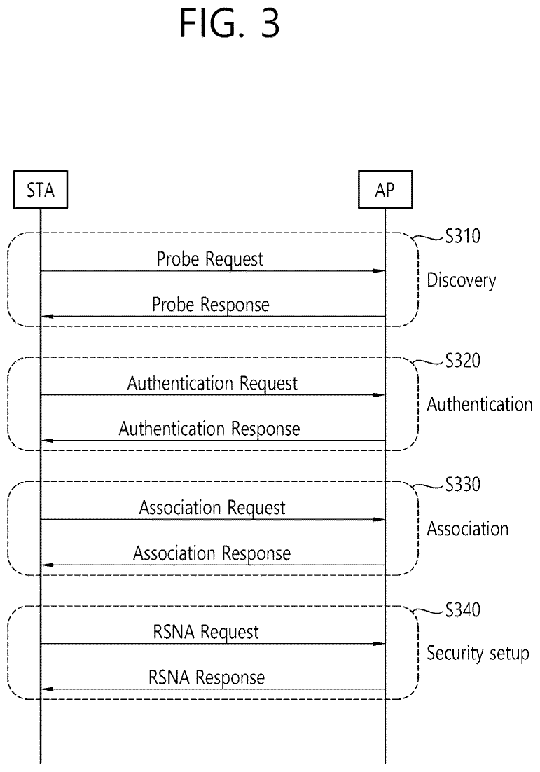

FIG. 3 illustrates a general link setup process.

In S310, a STA may perform a network discovery operation. The network discovery operation may include a scanning operation of the STA. That is, to access a network, the STA needs to discover a participating network. The STA needs to identify a compatible network before participating in a wireless network, and a process of identifying a network present in a particular area is referred to as scanning. Scanning methods include active scanning and passive scanning.

FIG. 3 illustrates a network discovery operation including an active scanning process. In active scanning, a STA performing scanning transmits a probe request frame and waits for a response to the probe request frame in order to identify which AP is present around while moving to channels. A responder transmits a probe response frame as a response to the probe request frame to the STA having transmitted the probe request frame. Here, the responder may be a STA that transmits the last beacon frame in a BSS of a channel being scanned. In the BSS, since an AP transmits a beacon frame, the AP is the responder. In an IBSS, since STAs in the IBSS transmit a beacon frame in turns, the responder is not fixed. For example, when the STA transmits a probe request frame via channel 1 and receives a probe response frame via channel 1, the STA may store BSS-related information included in the received probe response frame, may move to the next channel (e.g., channel 2), and may perform scanning (e.g., transmits a probe request and receives a probe response via channel 2) by the same method.

Although not shown in FIG. 3, scanning may be performed by a passive scanning method. In passive scanning, a STA performing scanning may wait for a beacon frame while moving to channels. A beacon frame is one of management frames in IEEE 802.11 and is periodically transmitted to indicate the presence of a wireless network and to enable the STA performing scanning to find the wireless network and to participate in the wireless network. In a BSS, an AP serves to periodically transmit a beacon frame. In an IBSS, STAs in the IBSS transmit a beacon frame in turns. Upon receiving the beacon frame, the STA performing scanning stores information related to a BSS included in the beacon frame and records beacon frame information in each channel while moving to another channel. The STA having received the beacon frame may store BSS-related information included in the received beacon frame, may move to the next channel, and may perform scanning in the next channel by the same method.

After discovering the network, the STA may perform an authentication process in S320. The authentication process may be referred to as a first authentication process to be clearly distinguished from the following security setup operation in S340. The authentication process in S320 may include a process in which the STA transmits an authentication request frame to the AP and the AP transmits an authentication response frame to the STA in response. The authentication frames used for an authentication request/response are management frames.

The authentication frames may include information related to an authentication algorithm number, an authentication transaction sequence number, a status code, a challenge text, a robust security network (RSN), and a finite cyclic group.

The STA may transmit the authentication request frame to the AP. The AP may determine whether to allow the authentication of the STA based on the information included in the received authentication request frame. The AP may provide the authentication processing result to the STA via the authentication response frame.

When the STA is successfully authenticated, the STA may perform an association process in S330. The association process includes a process in which the STA transmits an association request frame to the AP and the AP transmits an association response frame to the STA in response. The association request frame may include, for example, information related to various capabilities, a beacon listen interval, a service set identifier (SSID), a supported rate, a supported channel, RSN, a mobility domain, a supported operating class, a traffic indication map (TIM) broadcast request, and an interworking service capability. The association response frame may include, for example, information related to various capabilities, a status code, an association ID (AID), a supported rate, an enhanced distributed channel access (EDCA) parameter set, a received channel power indicator (RCPI), a received signal-to-noise indicator (RSNI), a mobility domain, a timeout interval (association comeback time), an overlapping BSS scanning parameter, a TIM broadcast response, and a QoS map.

In S340, the STA may perform a security setup process. The security setup process in S340 may include a process of setting up a private key through four-way handshaking, for example, through an extensible authentication protocol over LAN (EAPOL) frame.

### 1. Zigbee and Connected Home Over IP (CHIP)

### Necessity of Zigbee

Currently, there are standards for data such as voice, PC LANs, and video, but there are no wireless network standards to meet the specific needs of sensors or control devices. Sensors and control devices do not require high frequency bandwidth, but require short latency and low energy consumption for long battery life and a wide array of devices.

Today, various wireless communication systems that do not require high data rates and can operate at low cost and with low power consumption are being produced.

Products produced in this way are manufactured without standards, and eventually these past products cause compatibility problems with each product, as well as compatibility with new technologies.

### About Zigbee

ZigBee is a high-level communication protocol using small, low-power digital radios based on IEEE 802.15.4-2003. IEEE 802.15.4-2003 is a standard for short-range personal wireless communication networks such as lamps, electronic meters, and consumer electronics that use short-range radio frequencies. ZigBee is mainly used in RF (Radio Frequency) applications that require low data rates, low battery consumption, and network safety.

### Features of Zigbee

1) Low power consumption, simple implementation
2) Can be used for months or years on a single battery charge
3) It has an active mode (receive, transmit) and a sleep mode.
4) Device, installation, maintenance, etc. are all possible at relatively low cost
5) Safety (Security)
6) Reliability
7) Flexibility
8) Very small protocol stack
9) Interoperable and usable anywhere
10) High node density per network (ZigBee's use of IEEE 802.15.4 makes it possible to handle many devices in a network. This feature allows for massive sensor arrays and network control)
11) Simple protocol, implemented internationally (The size of the ZigBee protocol stack code is only about a quarter of the size of Bluetooth or 802.11.)

### Fields of Use of Zigbee

Zigbee is currently used in fields such as industrial control, embedded sensors, medical data collection, fire and theft, building automation, and home automation.

### 1) Smart Energy

Smart Energy provides utilities/energy service providers with a secure and easy-to-use home wireless network to manage energy. Smart Energy gives utilities/energy service providers or their customers direct control of thermostats or other associated devices.

### 2) Home Entertainment and Control

Smart power, advanced temperature control system, safety and security, movies and music

### 3) Home Recognition System

Water temperature sensor, power sensor, energy monitoring, fire and theft monitoring, smart devices and access sensors

### 4) Mobile Service

Mobile payment, mobile monitoring and control, mobile security and access control, mobile healthcare and remote support

### 5) Commercial Buildings

Energy monitoring, air conditioning, lighting, access control

### 6) Industrial Factories

Process control, material management, environment management, energy management, industrial device control, M2M communication

### Zigbee Device Type

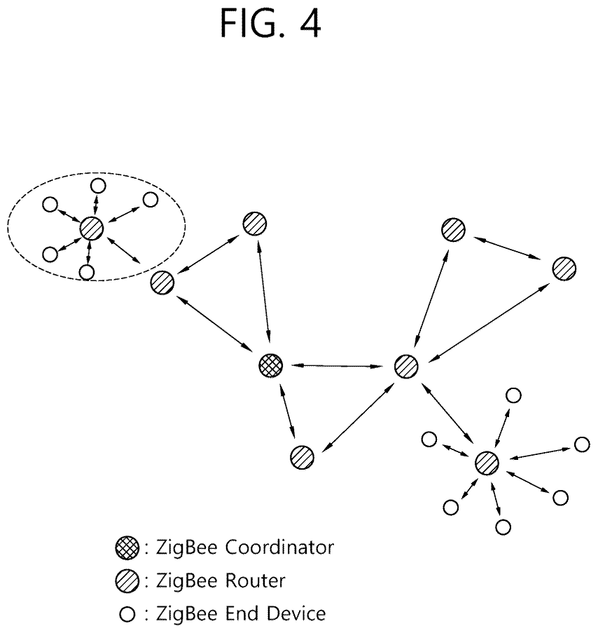

FIG. 4 shows Zigbee device types.

There are three types of Zigbee devices as shown in FIG. 4.

### 1) Zigbee Coordinator

It forms a network with the most important devices and connects them to other networks. Each network has only one coordinator. The ZigBee coordinator can store information about the network and also serves as a trust center or storage for security keys.

### 2) Zigbee Router

A router can function not only as an application function, but also as a writer that can forward data from other devices.

### 3) Zigbee End Device

ZigBee end devices include the ability to communicate with parent nodes. This relationship allows the node to wait a long time, extending battery life even further.

### Zigbee Stack

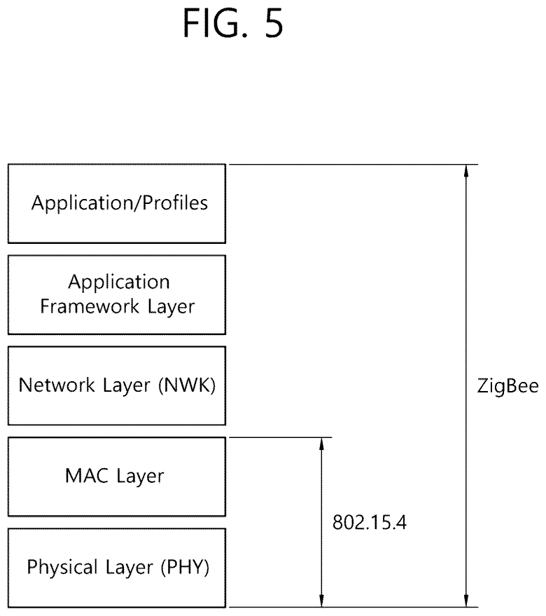

FIG. 5 shows a Zigbee stack.

Zigbee is simpler than many other protocol stacks, and the Zigbee stack code size is small compared to other protocols. MAC and PHY are defined by the IEEE 802.15.4 standard. Network and application layers are defined by the Zigbee Alliance and the actual application provided by equipment designers.

802.15.4 is a simple packet data protocol for lightweight wireless networks. 802.15.4 was created to monitor and control applications where battery life is critical. 802.15.4 is at the root of ZigBee's excellent battery life.

802.15.4 can apply both IEEE long/short addressing. Short addressing is used for network management where network IDs are provisionally determined. This makes it less costly, but still enables use of around 65,000 network nodes.

In addition, 802.15.4 enables reliable data transmission and beacon management.

The network layer ensures proper operation of the MAC layer and provides an interface to the application layer. The network layer supports star, tree, and mesh topologies. The network layer is where networks are started, joined, destroyed, and retrieved.

The network layer is responsible for routing and security.

The application framework is an execution environment in which application objects can send and receive data. The application object is determined by the manufacturer of the Zigbee device. As defined by Zigbee, the application object is located at the top of the application layer and is determined by the device manufacturer. The application object actually builds the application; This could be a light bulb, light switch, LED, I/O line, etc.

Looking at home appliances released these days, the modifier ‘smart’ is almost mandatory. It is difficult to find products that are not ‘smart’, such as smart TVs, smart refrigerators, smart air conditioners, and smart washing machines. These smart products implement various convenience functions based on IoT (Internet Of Things) technology, which is equipped with wired and wireless networks, communicates closely with each other, and interlocks with each other. If you combine various sensors with IoT technology, such as temperature and humidity sensors, door sensors, motion sensors, and IP cameras, you can use more precise and diverse automation functions.

When a number of these smart products are gathered and applied to one house, a ‘smart home’ is born. If you live in such a home, you can use a variety of automated or remote functions, such as automatically turning on lights or air conditioners when you are ready to go home from outside work, and automatically playing appropriate music depending on the day's weather. Other similar concepts include ‘smart building’ and ‘smart factory’.

However, there are side effects caused by the proliferation of smart products and the proliferation of products of various standards. It's just a compatibility issue. The core of IoT technology is communication and linkage between devices, and if each device uses a different IoT platform and does not link with each other, its usability is greatly reduced.

For example, if the speaker is a product based on the ‘Apple HomePod’ platform, but the TV is only compatible with the ‘Samsung SmartThings’ platform, you may not be able to use the function of turning on the TV or switching channels through voice commands. Of course, recently, one product supports two or more IoT platforms at the same time. Or, there is a way to decorate a smart environment by purchasing all products only based on the same platform. But even so, it is inconvenient to have to carefully check compatibility every time you buy a product.

But in the future you won't have to worry about that. This is because major IoT-related companies have gathered and announced standard specifications that enable all devices to be compatible without platform dependency. In May, the CSA (Connectivity Standards Alliance) standards association introduced an IoT standard protocol called ‘Matter’. Formerly known as Project CHIP (Connected Home over IP), the Matter standard is being supported by Amazon, Google, Signify (Philips Hue), SmartThings, and other major players in the smart home market.

There are dozens of companies that have participated in or announced cooperation in establishing Matter standards, including Samsung Electronics, Google, Amazon, Apple, Tuya, Huawei, and Schneider Electric, all of which are global companies with a high share in the IoT market. If the Matter standard spreads widely, all smart devices will now work seamlessly without having to worry about manufacturers or platforms.

Matter is an IP-based protocol that can run over existing network technologies such as Wi-Fi, Ethernet, and Thread. The federation said Matter devices can be easily set up using Bluetooth Low Energy (BLE). It is explained that users do not have to do complicated configuration work because smart home devices can inform each other of their identity and possible operations.

In particular, Matter's ‘multi-admin’ feature allows products from various ecosystems, such as Apple HomeKit and Amazon Alexa, to work together without complicated work by end users. Multi-Manager also sets up layers of control to help different family members connect to smart appliances in the home with different levels of control.

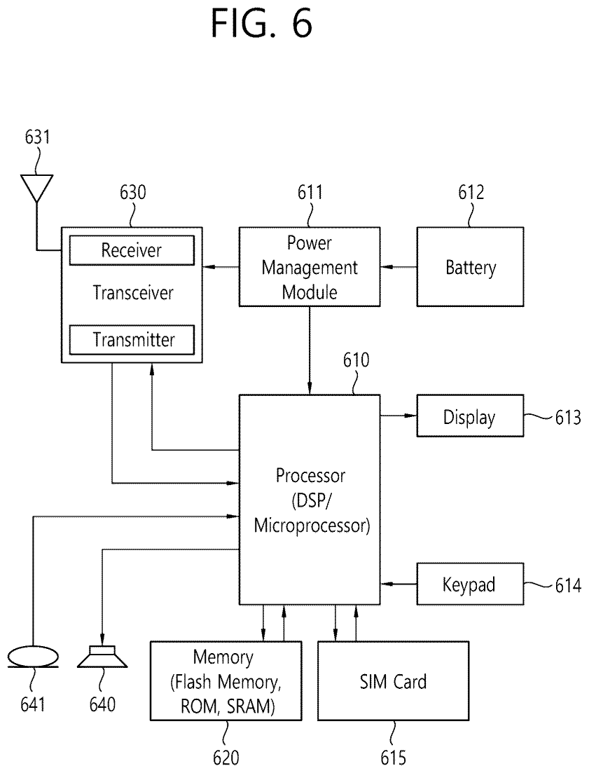

FIG. 6 shows a modified example of the transmitting device and/or the receiving device of the present specification.

Each device/STA of the sub-figure (a)/(b) of FIG. 1 may be modified as shown in FIG. 6. A transceiver 630 of FIG. 6 may be identical to the transceivers 113 and 123 of FIG. 1. The transceiver 630 of FIG. 6 may include a receiver and a transmitter.

A processor 610 of FIG. 6 may be identical to the processors 111 and 121 of FIG. 1. Alternatively, the processor 610 of FIG. 6 may be identical to the processing chips 114 and 124 of FIG. 1.

A memory 620 of FIG. 6 may be identical to the memories 112 and 122 of FIG. 1. Alternatively, the memory 620 of FIG. 6 may be a separate external memory different from the memories 112 and 122 of FIG. 1.

Referring to FIG. 6, a power management module 611 manages power for the processor 610 and/or the transceiver 630. A battery 612 supplies power to the power management module 611. A display 613 outputs a result processed by the processor 610. A keypad 614 receives inputs to be used by the processor 610. The keypad 614 may be displayed on the display 613. A SIM card 615 may be an integrated circuit which is used to securely store an international mobile subscriber identity (IMSI) and its related key, which are used to identify and authenticate subscribers on mobile telephony devices such as mobile phones and computers.

Referring to FIG. 6, a speaker 640 may output a result related to a sound processed by the processor 610. A microphone 641 may receive an input related to a sound to be used by the processor 610.

### 2. Embodiments Applicable to this Specification

With the advent of the IoT (Internet of Things) Connectivity era, various devices in the home, such as TVs, air conditioners, and light bulbs, now have Internet Protocol functions, making communication between devices possible. However, unlike the organic platform configuration between all products thought by consumers, due to the development of this era is due to diversified IoT standardization (WIFI, BLE, Thread, Zigbee, etc.) and product manufacturing by various manufacturers (LG, Samsung, Apple, etc.), problems have arisen regarding the lack of stability in interoperability between products of different standards and different manufacturers, as well as the high cost of going through the cloud.

In addition, media processing technology has also progressed greatly, making it possible to analyze the user's tastes and filter the desired scenes by analyzing the scenes and sounds of the media consumed by the user, but scenarios utilizing this are still insignificant.

This specification explains how to enable more convenient and immersive media consumption for users by analyzing the media consumed by the device, checking the current status of nearby devices, and adjusting their operations. In other words, in the process of interpreting media to be consumed, a method for control ambient lighting, curtains, temperature, wind, etc. is proposed by analyzing the color, brightness, location, and scenario that the current media wants to express through deep learning and artificial intelligence, so that users can play media in an immersive way.

In particular, this embodiment is about controlling the operation of peripheral devices according to media data using IoT technology based on a D2D (Device-to-Device) connection structure that directly controls devices like Matter (CHIP; Connected Home over IP) standard technology.

This specification proposes a method of controlling peripheral devices in a device using D2D-based Matter standard technology and media analysis & processing technology. In the case of IoT devices, in order to control devices such as smartphones, tablets, TVs, wall pads, etc., it can be divided into the role of the controller (Commissioner, Admin), which registers and actually controls the device, and the controlee (Commissionee), such as light bulbs, sensors, curtains, etc., that are controlled by the controller.

In this specification, peripheral devices (Controlee) transmit their device type, location, adjustable data, etc. to the Controller. Afterwards, the Controller analyzes media data such as video, audio, subtitles, etc. and analyzes the data required in the process (Decoding, Rendering, etc.).

In addition, this specification suggests a method for providing users with an immersive experience beyond simple video and sound by having the controller operate or control peripheral devices connected to the controller, such as lights, fans, and blinds, based on the analyzed data.

### 2.1. Configuration and Outline of this Embodiment

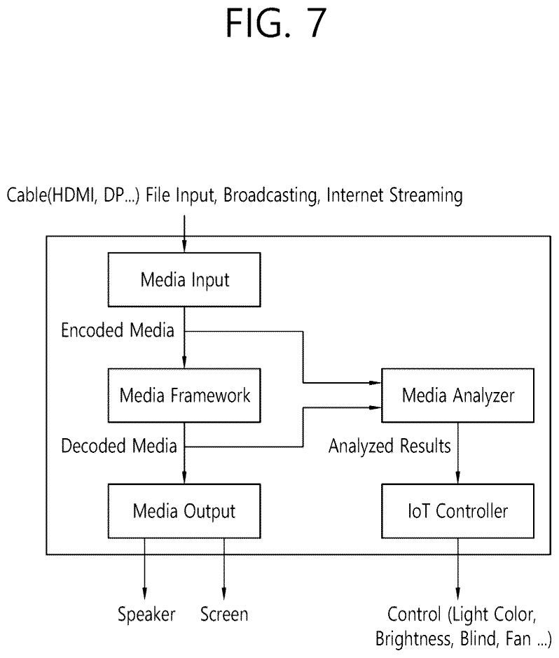

The device proposed in this embodiment consists of i) a part that receives and processes media input, ii) a part that analyzes media data, and iii) a part that controls peripheral devices based on the analyzed results as shown in FIG. 7 below.

FIG. 7 shows the configuration of Controller proposed in this embodiment.

The devices described in this embodiment are mainly devices that receive and consume media input, for example, devices such as TVs, smartphones, tablets, and projectors. This specification is not limited to the device currently described, but the configuration shown in FIG. 7 can also be applied to other types of devices. The device in FIG. 7 has a Media Input module that can receive media input. Media can be input through receiving video or audio input through a cable, such as HDMI (High Definition Multimedia Interface), or can be input through reception of broadcast signals through a medium such as an antenna, or can be input through the reception of media information from digital files through a file storage device, or can be input through receiving media data through Internet Streaming, such as a content provider. The media data received in this way is processed through a media framework and delivered to the output device. At this time, the media framework may correspond to a decoder for playing media information. Decoded data is output to the screen or speaker, and the part responsible for output is the Media Output module. Currently, TVs, smartphones, etc. can process media based on the structures of Media Input, Media Framework, and Media Output.

The device described in this embodiment includes a Media Analyzer and an IoT Controller as additional components. Media Analyzer analyzes current media information based on media information. In other words, information such as color and brightness that the current media mainly expresses is extracted, or the background color and scene viewpoint of the current media are analyzed. For example, this is a module that extracts meaningful information from media information such as information that the average color of the current media is mainly green, the scene expressed by the current media is a night scene, or the time of the video is winter can be converted into simple digital information and performs deep learning using artificial intelligence. The results analyzed through the Media Analyzer module are delivered to the IoT Controller module that can control nearby IoT devices. The IoT Controller module is responsible for registering, checking the status, and controlling controllable IoT devices. In other words, it uses wired/wireless communication protocols to check and control the status of nearby light bulbs, sensors, fans, etc. In this specification, Matter (Connected Home over IP) standard technology is exemplified as an example of the relevant IoT Controller technology, but it is not limited to the Matter standard technology and can also be configured through other IoT Controller technologies.

### 2.2. Environment for Technology Application

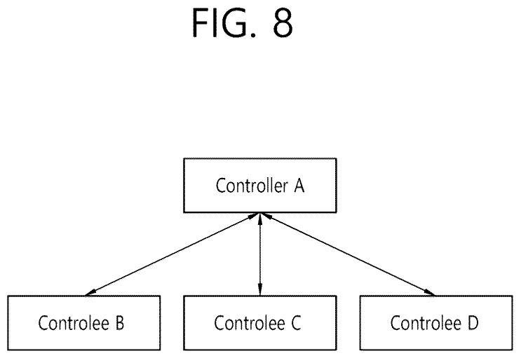

As shown in FIG. 8, the environment proposed in this specification has a Controller and one or more Controlees, and each Controller is independently connected to the Controlees.

FIG. 8 shows the connection structure of Controller and Controlee.

For example, if the Controller and Controlee are devices that support the Matter standard, they can commission each other according to the Matter standard. During this process, the Controller can obtain information about the Controlee's manufacturer name, type, location, and adjustable data.

Afterwards, the Controller takes into account the manufacturer, device type, location, current status value, etc. of each Controlee according to the processing of the media and delivers commands such as appropriate control commands, scheduled operation time, scheduled operation end time, and brightness to the Controlee to enable operation tailored to the situation.

### 2.3. Control Connected Peripheral Devices Based on Media Data Extracted from the Decoding Process

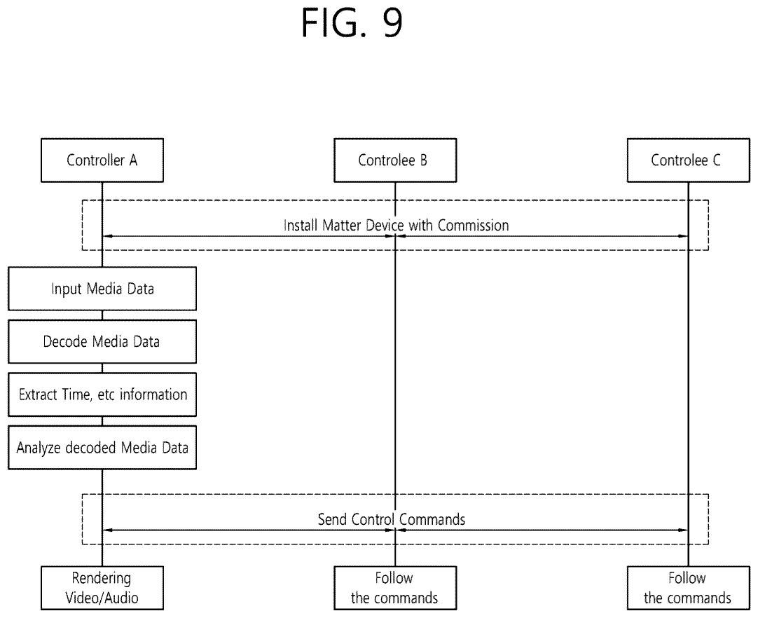

FIG. 9 shows a procedure for controlling Controlees during the media decoding process.

FIG. 9 is a method of controlling Controlees by extracting and analyzing media data during the media decoding process and determining the appropriate situation.

Referring to FIG. 9, according to existing standards, a commission is preceded between the controller and one or more controllers. During this process, the Controller recognizes the Controlee's Configure information.

The Controller first sets the control authority of the Controlee, extracts additional information of the encoded media frame during the decoding process of media such as video, audio, and subtitle, and then determines media information and appropriate operation control commands for the Controlee.

If necessary, the Controller determines appropriate operation control commands for peripheral devices through decrypted media processing technology before playback and then delivers them to each Controlee.

The Controlee who received the command executes the received command at the time the media data is played.

### 2.3.1. Example of Controlling Connected Peripheral Devices Based on Media Data Extracted from the Decoding Process

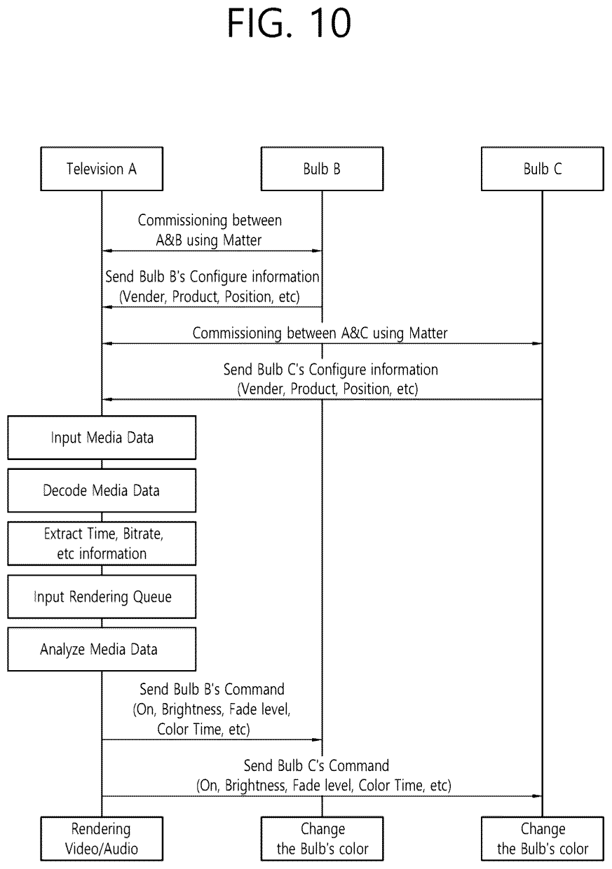

FIG. 10 shows an embodiment of controlling Controlees during the media decoding process.

FIG. 10 shows an example of controlling the Controlee by extracting and analyzing media data in the media decoding process and determining the appropriate situation.

FIG. 10 shows the control process between Television A, which plays the role of Controller, and Bulb B and Bulb C, which play the role of Controlee.

For Television A and Bulb B, Commission comes first according to the Matter standard. In this process, Television A recognizes Bulb B's configuration information (manufacturer name, product type, location, network status, current status value, etc.). After the commission with Bulb B is completed, Television A proceeds with the commission with Bulb C. Likewise, Television A recognizes Bulb C's configuration information through this.

Afterwards, Television A receives media data and analyzes additional media information (timestamp, width, height, bitrate, language, etc) in the process of decoding the information. The decrypted media data determines the appropriate control commands (On/Off, brightness, lighting color, fade speed, etc.) for Bulb B and Bulb C, if necessary, using media processing technologies such as object recognition, background recognition, and voice recognition before playback.

When the media playback point is reached on Television A, Bulb B and Bulb C execute the received commands.

This embodiment has the advantage of making it easy to predict control values to be changed by first analyzing a large number of media data accumulated in the buffer before rendering. For example, the Controller determines the appropriate color and fade-in value according to the location of each light bulb by predicting the brightness and color according to the difference between the current video frame scene value and the future video frame scene value. Command transmission is possible.

### 2.3.2. Example of Control Commands for Connected Peripheral Devices Based on Media Data Extracted During the Decoding Process

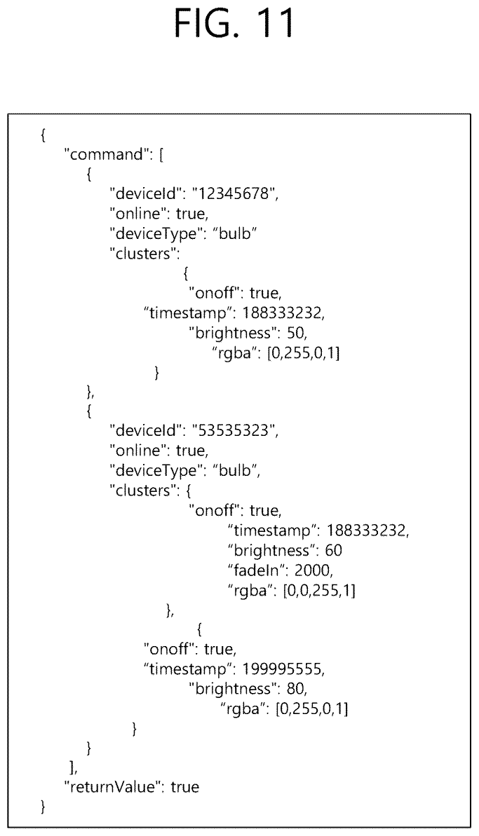

FIG. 11 is an example of coding showing control processing commands for Controlees during the media decoding process.

FIG. 11 shows an example of a command in which the Controller extracts and analyzes media data in the media decoding process, determines an appropriate situation, and controls the Controlee.

The example in FIG. 11 is configured in Json format, and xml, Sudo Code, etc. may be additionally configured as needed. It is not limited to this and can be configured in other ways as well. [179] 2.4. Control connected peripheral devices based on media data extracted from the rendering process

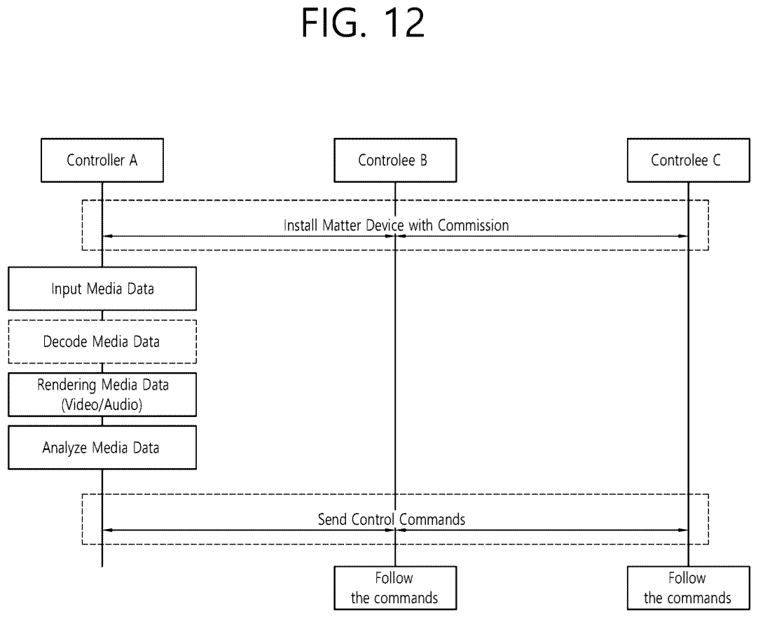

FIG. 12 shows the procedure for controlling Controlees after media playback processing.

FIG. 12 shows how the Controller analyzes media data in the media playback process (rendering), determines an appropriate situation, and controls Controlees.

As in 2.2, a commission between the controller and one or more controllers precedes it, and then the controller recognizes the configure information for each controller.

In the example of FIG. 12, the Controller analyzes information about the media frame being played after decoding. When processing such as object recognition, background recognition, and voice recognition within the media frame being played is performed, based on the information recognized about the media scene, voice, and situation, the Controller delivers media information and appropriate action control commands to the Controlee.

The Controlee who receives the command executes the command immediately or at an appropriate time according to the command received. [185] 2.4.1. Example of controlling connected peripheral devices based on media data extracted from the rendering process

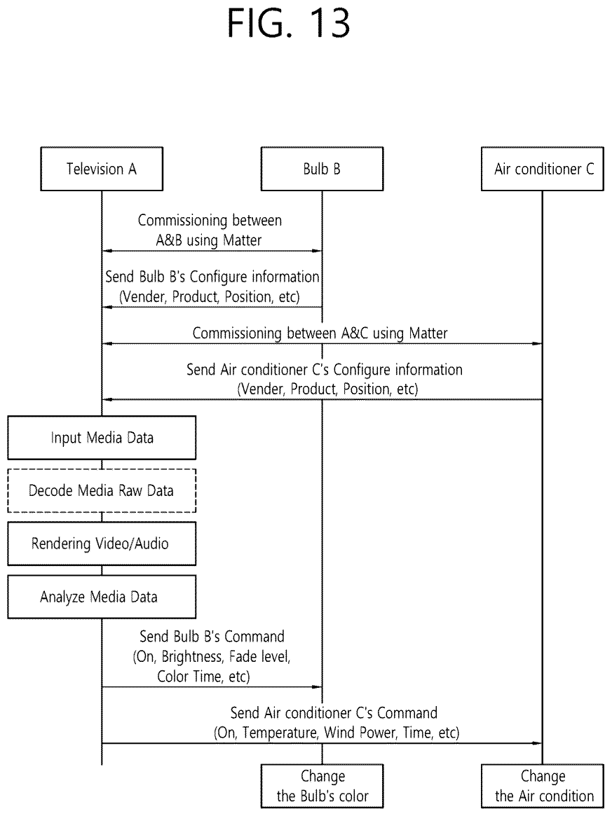

FIG. 13 shows an example of control processing of Controlees after media playback processing.

FIG. 13 shows an example of controlling the Controlee by analyzing media data in the media playback process (rendering), determining an appropriate situation, and controlling the Controlee.

An example in FIG. 13 shows the controlled process between Television A, which plays the role of Controller, and Bulb B and Air Conditioner C, which play the role of Controlee.

For Television A and Bulb B, Commission comes first according to the Matter standard. In this process, Television A recognizes Bulb B's configuration information (manufacturer name, product type, location, network status, current status value, etc.).

After the commission with Bulb B is completed, Television A proceeds with the commission with Air Conditioner C. Likewise, Television A recognizes the configuration information of Air Conditioner C through this.

Afterwards, Television A can receive the media data, decode the information, and then play the media data. During the playback process, Television A determines Bulb B's control commands (On/Off, brightness, lighting color, fade speed, etc.) and Air Conditioner C's control commands (On/Off, wind power, temperature, etc.) using media processing technologies such as object recognition in video, background recognition, and voice recognition in audio,

Bulb B and Air Conditioner C execute the control command immediately upon receiving it or at an appropriate time.

This embodiment shows that even in an environment where the Controller does not directly decode the media, it is possible to analyze the media and deliver commands to each Controlee. For example, this embodiment can be applied even when the subject of media decoding is not the controller, such as in a situation where a television and an Internet Protocol Television (IPTV) set-top box or console game console are connected via HDMI.

### 2.4.2. Example of Control Commands for Connected Peripheral Devices Based on Media Data Extracted from the Playback Process (Rendering)

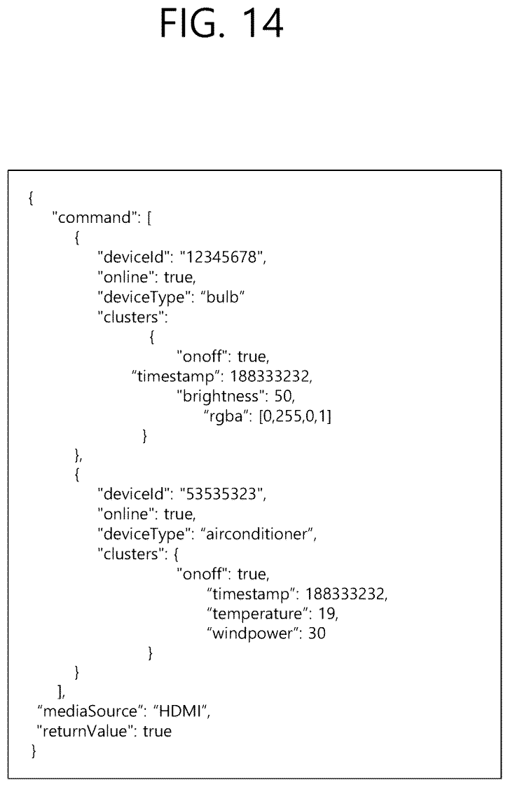

FIG. 14 is an example of coding showing control processing commands for Controlees after media playback processing.

FIG. 14 shows an example of a command for controlling the Controlee by analyzing media data in the media playback process (rendering), determining an appropriate situation, and controlling the Controlee.

The example in FIG. 14 is configured in Json format, and xml, Sudo Code, etc. may be additionally configured as needed. It is not limited to this and can be configured in other ways as well.

Hereinafter, the above-described embodiment will be described with reference to FIGS. 1 to 14.

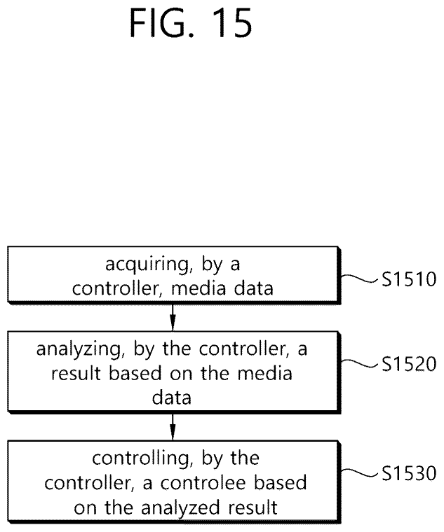

FIG. 15 is a flowchart illustrating a procedure in which a controller acquires and analyzes media data and controls a controlee according to this embodiment.

This embodiment proposes a method in which the controller (IoT controller) analyzes the necessary data in the process of acquiring and processing media data such as video, audio, and subtitles, and operates or controls controlee (IoT controlee or peripheral devices) connected to controller such as lights, fans, and blinds based on the analyzed data.

In step S1510, a controller acquires media data.

In step S1520, the controller analyzes a result based on the media data.

In step S1530, the controller controls a controlee based on the analyzed result.

The media data is obtained based on cable, file input, broadcasting, and Internet streaming. The cable may be a cable for transmitting video/audio signals, such as High-Definition Multimedia Interface (HDMI) or DisplayPort (DP). The broadcasting may refer to a method of transmitting broadcasts using radio waves, such as TV The Internet streaming is a method of playing audio or video in real time on the Internet, and may refer to a streaming service such as YouTube or Netflix.

The controlee may include first and second controlees.

The controller may perform commissioning with the first and second controlees based on the WLAN system. The WLAN system may include Matter standard technology or IoT technology other than Matter. The controller may receive configuration information on the first controlee from the first controlee. The controller may receive configuration information on the second controlee from the second controlee. The controller and the controlee may be connected to each other through Device-to-Device (D2D), which directly controls the devices through matter standard technology.

The configuration information on the first and second controlees may include a manufacturer name, product type, device location, network status, or current status of a device.

The analysis result may include a timestamp, width and height, bitrate, language, frame rate, or compression information (codec) of the media data.

This specification suggests a first embodiment in which the controller controls the connected controlee (peripheral device) based on media data extracted during the decoding process and a second embodiment in which the controller controls the connected controlee (peripheral device) based on media data extracted during the rendering process.

According to the first embodiment, the controller may input the media data. The controller may decode the input media data. The controller may extract and analyze the decoded media data. The controller may determine and transmit a control command suitable for the first and second controlees based on the analyzed media data. The controller may render the decoded media data. The first and second controlees may perform a command based on the control command. At this time, the media data may include audio or video data.

When the first and second controlees are bulbs, the control command may be a command for on/off, brightness, lighting color, and fade speed of the light bulb.

When the first and second controlees are air conditioners, the control command may be a command for on/off, temperature, wind strength, and timer of the air conditioner.

According to the second embodiment, the controller may input the media data. The controller may render the input media data. The controller may extract and analyze the rendered media data. The controller may determine and transmit a control command suitable for the first and second controlees based on the analyzed media data. The first and second controlees may perform a command based on the control command. At this time, the media data may include audio or video data.

According to this embodiment, the IoT controller acquires and analyzes the media data and controls peripheral devices with the analyzed result, which has the effect of allowing users to consume media more conveniently and immersively without user intervention. For example, in interpreting media data for consumption, through deep learning, artificial intelligence, etc., the color, brightness, and scenario that the current media data is intended to express are analyzed and the lighting, curtains, temperature, wind, etc. of surrounding devices are adjusted, and it can allow users to consume media in an immersive way.

### 3. Device Configuration

The technical features of the present disclosure may be applied to various devices and methods. For example, the technical features of the present disclosure may be performed/supported through the device(s) of FIG. 1 and/or FIG. 6. For example, the technical features of the present disclosure may be applied to only part of FIG. 1 and/or FIG. 6. For example, the technical features of the present disclosure may be implemented based on the processing chip(s) 114 and 124 of FIG. 1, or implemented based on the processor(s) 111 and 121 and the memory(s) 112 and 122, or implemented based on the processor 610 and the memory 620 of FIG. 6. For example, the device of the present specification is a device operating in a wireless LAN system in a smart home environment, and the device includes a memory and a processor operably coupled to the memory, wherein the processor is configured to acquire media data; analyze a result based on the media data; and control a controlee based on the analyzed result.

The technical features of the present disclosure may be implemented based on a computer readable medium (CRM). For example, a CRM according to the present disclosure is at least one computer readable medium including instructions designed to be executed by at least one processor.

The CRM may store instructions that perform operations including acquiring media data; analyzing a result based on the media data; and controlling a controlee based on the analyzed result. At least one processor may execute the instructions stored in the CRM according to the present disclosure. At least one processor related to the CRM of the present disclosure may be the processor 111, 121 of FIG. 1, the processing chip 114, 124 of FIG. 1, or the processor 610 of FIG. 6. Meanwhile, the CRM of the present disclosure may be the memory 112, 122 of FIG. 1, the memory 620 of FIG. 6, or a separate external memory/storage medium/disk.

The foregoing technical features of the present specification are applicable to various applications or business models. For example, the foregoing technical features may be applied for wireless communication of a device supporting artificial intelligence (AI).

Artificial intelligence refers to a field of study on artificial intelligence or methodologies for creating artificial intelligence, and machine learning refers to a field of study on methodologies for defining and solving various issues in the area of artificial intelligence. Machine learning is also defined as an algorithm for improving the performance of an operation through steady experiences of the operation.

An artificial neural network (ANN) is a model used in machine learning and may refer to an overall problem-solving model that includes artificial neurons (nodes) forming a network by combining synapses. The artificial neural network may be defined by a pattern of connection between neurons of different layers, a learning process of updating a model parameter, and an activation function generating an output value.

The artificial neural network may include an input layer, an output layer, and optionally one or more hidden layers. Each layer includes one or more neurons, and the artificial neural network may include synapses that connect neurons. In the artificial neural network, each neuron may output a function value of an activation function of input signals input through a synapse, weights, and deviations.

A model parameter refers to a parameter determined through learning and includes a weight of synapse connection and a deviation of a neuron. A hyper-parameter refers to a parameter to be set before learning in a machine learning algorithm and includes a learning rate, the number of iterations, a mini-batch size, and an initialization function.

Learning an artificial neural network may be intended to determine a model parameter for minimizing a loss function. The loss function may be used as an index for determining an optimal model parameter in a process of learning the artificial neural network.

Machine learning may be classified into supervised learning, unsupervised learning, and reinforcement learning.

Supervised learning refers to a method of training an artificial neural network with a label given for training data, wherein the label may indicate a correct answer (or result value) that the artificial neural network needs to infer when the training data is input to the artificial neural network. Unsupervised learning may refer to a method of training an artificial neural network without a label given for training data. Reinforcement learning may refer to a training method for training an agent defined in an environment to choose an action or a sequence of actions to maximize a cumulative reward in each state.

Machine learning implemented with a deep neural network (DNN) including a plurality of hidden layers among artificial neural networks is referred to as deep learning, and deep learning is part of machine learning. Hereinafter, machine learning is construed as including deep learning.

The foregoing technical features may be applied to wireless communication of a robot.

Robots may refer to machinery that automatically process or operate a given task with own ability thereof. In particular, a robot having a function of recognizing an environment and autonomously making a judgment to perform an operation may be referred to as an intelligent robot.

Robots may be classified into industrial, medical, household, military robots and the like according uses or fields. A robot may include an actuator or a driver including a motor to perform various physical operations, such as moving a robot joint. In addition, a movable robot may include a wheel, a brake, a propeller, and the like in a driver to run on the ground or fly in the air through the driver.

The foregoing technical features may be applied to a device supporting extended reality.

Extended reality collectively refers to virtual reality (VR), augmented reality (AR), and mixed reality (MR). VR technology is a computer graphic technology of providing a real-world object and background only in a CG image, AR technology is a computer graphic technology of providing a virtual CG image on a real object image, and MR technology is a computer graphic technology of providing virtual objects mixed and combined with the real world.

MR technology is similar to AR technology in that a real object and a virtual object are displayed together. However, a virtual object is used as a supplement to a real object in AR technology, whereas a virtual object and a real object are used as equal statuses in MR technology.

XR technology may be applied to a head-mount display (HMD), a head-up display (HUD), a mobile phone, a tablet PC, a laptop computer, a desktop computer, a TV, digital signage, and the like. A device to which XR technology is applied may be referred to as an XR device.

The claims recited in the present specification may be combined in a variety of ways. For example, the technical features of the method claims of the present specification may be combined to be implemented as a device, and the technical features of the device claims of the present specification may be combined to be implemented by a method. In addition, the technical characteristics of the method claim of the present specification and the technical characteristics of the device claim may be combined to be implemented as a device, and the technical characteristics of the method claim of the present specification and the technical characteristics of the device claim may be combined to be implemented by a method.

1. A method in a wireless local area network (WLAN) system of a smart home environment, the method comprising:
acquiring, by a controller, media data;
analyzing, by the controller, a result based on the media data; and
controlling, by the controller, a controlee based on the analyzed result,
wherein the media data is obtained based on cable, file input, broadcasting, and Internet streaming.

2. The method of claim 1, wherein the controlee includes first and second controlees.

3. The method of claim 2, further comprising:
performing, by the controller, commissioning with the first and second controlees based on the WLAN system;
receiving, by the controller, configuration information on the first controlee from the first controlee; and
receiving, by the controller, configuration information on the second controlee from the second controlee.

4. The method of claim 3, further comprising:
inputting, by the controller, the media data;
decoding, by the controller, the input media data;
extracting and analyzing, by the controller, the decoded media data;
determining and transmitting, by the controller, a control command suitable for the first and second controlees based on the analyzed media data; and
rendering, by the controller, the decoded media data,
wherein the media data includes audio or video data,
wherein the first and second controlees perform a command based on the control command.

5. The method of claim 4, wherein when the first and second controlees are bulbs, the control command is a command for on/off, brightness, lighting color, and fade speed of the light bulb.

6. The method of claim 4, wherein when the first and second controlees are air conditioners, the control command is a command for on/off, temperature, wind strength, and timer of the air conditioner.

7. The method of claim 3, further comprising:
inputting, by the controller, the media data;
rendering, by the controller, the input media data;
extracting and analyzing, by the controller, the rendered media data; and
determining and transmitting, by the controller, a control command suitable for the first and second controlees based on the analyzed media data,
wherein the media data includes audio or video data,
wherein the first and second controlees perform a command based on the control command.

8. The method of claim 3, wherein the configuration information on the first and second controlees includes a manufacturer name, product type, device location, network status, or current status of a device.

9. The method of claim 1, wherein the analysis result includes a timestamp, width and height, bitrate, language, frame rate, or compression information (codec) of the media data.

10. A controlee in a wireless local area network (WLAN) system of a smart home environment, the controlee comprising:
a memory;
a transceiver; and
a processor being operatively connected to the memory and the transceiver,
wherein the processor is configured to:
acquire media data;
analyze a result based on the media data; and
control a controlee based on the analyzed result,
wherein the media data is obtained based on cable, file input, broadcasting, and Internet streaming.

11. The method of claim 10, wherein the controlee includes first and second controlees.

12. The method of claim 11, wherein the processor is further configured to:
perform commissioning with the first and second controlees based on the WLAN system;
receive configuration information on the first controlee from the first controlee; and
receive configuration information on the second controlee from the second controlee.

13. The method of claim 12, wherein the processor is further configured to:
input the media data;
decode, the input media data;
extract and analyze, the decoded media data;
determine and transmit a control command suitable for the first and second controlees based on the analyzed media data; and
render the decoded media data,
wherein the media data includes audio or video data,
wherein the first and second controlees perform a command based on the control command.

14. The method of claim 13, wherein when the first and second controlees are bulbs, the control command is a command for on/off, brightness, lighting color, and fade speed of the light bulb.

15. The method of claim 13, wherein when the first and second controlees are air conditioners, the control command is a command for on/off, temperature, wind strength, and timer of the air conditioner.

16. The method of claim 12, wherein the processor is further configured to:
input the media data;
render the input media data;
extract and analyze the rendered media data; and
determine and transmit a control command suitable for the first and second controlees based on the analyzed media data,
wherein the media data includes audio or video data,
wherein the first and second controlees perform a command based on the control command.

17. The method of claim 12, wherein the configuration information on the first and second controlees includes a manufacturer name, product type, device location, network status, or current status of a device.

18. The method of claim 10, wherein the analysis result includes a timestamp, width and height, bitrate, language, frame rate, or compression information (codec) of the media data.

19. A computer readable medium including an instruction being executed by at least one processor and performing a method comprising the steps of:
acquiring media data;
analyzing a result based on the media data; and
controlling a controlee based on the analyzed result,
wherein the media data is obtained based on cable, file input, broadcasting, and Internet streaming.

20. (canceled)
